(19) United States
(12) Patent Application Publication
(10) Pub. No.: US 2005/0170321 A1
(43) Pub. Date: Aug. 4, 2005

(54) Method and system for career assessment

(76) Inventor: Helen M. Scully, Sacramento, CA (US)

Correspondence Address: CHARLES LOUIS THOEMING, 1390 WILLOW PASS ROAD, SUITE 1020, CONCORD, CA, 94520, US

(21) Appl. No.: 10/768,929

(22) Filed: Jan. 30, 2004

(51) Int. Cl. G06F 17/60; G09B 19/00

(52) U.S. Cl. 434/219; 434/236; 705/11

(57) ABSTRACT

Methods, systems, and articles of manufacture consistent with the present invention provide the ability for a user to integrate the basic elements of career self-assessment, research, decision-making and action planning. The outcome of the self-assessment steps of the present invention is based on four temperaments to yield a well-organized Action Plan which defines clear strategic steps to a path that will lead to a rewarding career. The system includes a computerized network environment designed and configured to implement the claimed method. A computer readable medium containing instructions for implementation of the claimed method is further disclosed.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

The present invention relates to methods and systems which integrate the basic elements of career self-assessment, research, decision-making and action planning. In particular, it provides a single, internally integrated assessment, which includes a complete assessment of values, skills, career interest and personality, which, in turn, are linked to a temperament theme, ranking, research and action planning process for employees, job seekers, homemakers and students looking for career direction or considering a career change. The method can be practiced manually using the card sort kit provided by an embodiment of the present invention. The system includes a computerized network environment designed and configured to implement the claimed method. A computer readable medium containing instructions for implementation of the claimed method is further disclosed.

2. Description of the Related Art

A search of the prior art located the following United States patents which are believed to be representative of the present state of the prior art: U.S. Pat. No. 4,337,048, issued Jun. 29, 1982, U.S. Pat. No. 5,671,409, issued Sep. 23, 1997, and U.S. Pat. No. 5,879,165, issued Mar. 9, 1999.

U.S. Pat. No. 4,337,048, issued Jun. 29, 1982, discloses a mechanical self-contained training system for providing simulated tools and tasks relating to specific occupations.

U.S. Pat. No. 5,671,409, issued Sep. 23, 1997, discloses a method for accessing career information located in a computer database through interactive CD-ROM or other suitable computer-accessible means.

U.S. Pat. No. 5,879,165, issued Mar. 9, 1999, features a method for creating and comprehensively analyzing in an integrated manner a test and course of study or job performance.

### BRIEF SUMMARY OF THE INVENTION

The present invention relates to a comprehensive, integrated, current career assessment method to link an individual's career criteria defined as temperament parameters (preferred values, skills, interests and personality requirements) to specific career alternatives.

In particular, the present invention includes a method which facilitates career assessment for a counselor, coach, supervisor, parent, teacher or individual. It requires no special training to use. It is a useful remedy to the confusion and frustration of multiple career assessments that often are not designed to work together. The straightforward format and writing style of the method of the present invention makes this tool truly user friendly and comfortably self-administered. The interactive card sort process of an embodiment of the method of the present invention involves the user in a way that is conducive to reflection, careful consideration and action planning.

Use of a single interest assessment or personality assessment common in the art does not provide adequate direction. If a person is going to consider a transition or make a career choice, it is critical that they understand four essential career related criteria: (i) their values (what is important to them); (ii) their skills (what they are good at); (iii) their interests (naturally occurring urges towards a subject matter or industry); and (iv) their personality (the environment that supports them best). All four assessment elements must be considered and integrated into the overall career assessment.

An added deficiency in the art, beyond lack of coordination, is wide, and often, uncorrelated variation in assessment scoring. Some tests are conducted by mail. These methods are lacking in that immediate feedback to the user is compromised by having to wait for the results. Other methods provided hand scored systems and others use recording sheets. Both recording methods are quite labor intensive and slow.

The existing art fails to provide a necessary link at the end of the assessment process. Often, unrelated tools are administered, with no logical way to correlate the results from each category into a single career profile or composite result. Issues of barriers to success, decision-making and career research are not integrated into existing career assessment tools. Generally, various exercises are tacked on after the administration of the assessments in the art and, as with the underlying methodologies, these practices are not linked directly to career assessment results.

The method of the present invention provides a tool that integrates the basic elements of career self-assessment with research, decision-making and action planning. It provides an integrated solution for employees, job seekers, homemakers and students looking for career direction or considering a career change.

The method and system of the present invention is particularly useful for individuals to address the “What Do I Do If I Don't Know What I Want To Do” issue. During typical career evolution and changes, an individual will experience ups and downs. Periods of cyclical reflection are normal and healthy. The method of the present invention assists the individual to identify strengths and career options. Through the method of the present invention, the user gains new insights as each exercise is completed and the elements of a Career Profile are organized. And, as the process is completed, the method of the present invention enables the user to select potential career options. The outcome of the self-assessment steps provided under the method of the present invention is a well-organized Action Plan created by the user which defines clear strategic steps to a path that will lead to a rewarding career.

An important step in beginning the career assessment is clarification of goals. Users who have been undecided for a long time may face additional obstacles. Career choice is only one of the issues such users face. They also may lack the time or the money to meet particular objectives. The method of the present invention provides an assessment tool to help the user identify the types of responsibilities and projects to be incorporated into their work to increase advancement opportunities and financial reward. The method of the present invention also clarifies leadership capabilities.

The method of the present invention carefully assesses the user's unique set of values, talents and interests that can be put to productive use. The more closely a user's career reflects their values and natural capabilities, the greater their contribution will be to their organization, their family, their community, and society as a whole. Career choice is an important personal and professional challenge. The method of the present invention is designed to facilitate good decision-making for career choice.

The method of the present invention is four career assessment tools in one, with a companion Elevations™ workbook. One embodiment of the method of the present invention is practiced using manual card sorts to assist in this evaluation process. Cards provide a useful embodiment because they are fun, active and easily sorted and arranged. The user does not get “stuck” with a label or static profile. With the manual, card sort embodiment of the present invention, the user is the author and the editor.

The method of the present invention is also available in electronic versions allowing for interactive use through the World Wide Web (www) portion of Internet access or stand-alone software by CD-ROM, or similar digital media.

It is an object of the present invention to provide a simple and practical method which implements a novel approach in determining an individual's career related preferences essential to career decisions.

It is still further an object of the present invention to provide a simple and practical method which implements a novel approach in determining an individual's career interests.

It is another object of the present invention to provide a method in which such determinations use a coordinated process of evaluating an individual's stated career interests, personal values and skills.

It is still another object of the present invention to provide a method wherein coordination of the individual's stated career interests, personal values and skills is made into one assessment.

It is a further object of the present invention to provide a method wherein each evaluation of an individual's career interests, values, and skills interrelate to a specific identifiable result in an ordered career roster.

It is still a further object of the present invention to provide a method to determine an individual's temperament and associated career interests.

It is yet another object of the present invention to provide a method which facilitates career assessment in a broad range of application by counselor, coach, supervisor, parent, teacher or individual.

### BRIEF DESCRIPTION OF DRAWINGS

The above and other objects and advantages of the invention will be apparent upon consideration of the following detailed description, taken in conjunction with the accompanying drawings, in which like reference characters refer to like parts throughout, and in which:

FIG. 1 is a flowchart representation of a preferred embodiment of the data processing method for user values assessment according to the invention.

FIG. 2 is a flowchart representation of a preferred embodiment of the data processing method for user skills assessment according to the invention.

FIG. 3 is a flowchart representation of a preferred embodiment of the data processing method for user career interests assessment according to the invention.

FIG. 4 is a flowchart representation of a preferred embodiment of the data processing method for user personality themes assessment according to the invention.

FIG. 5 is a flowchart of the steps following FIGS. 1-4 of a preferred embodiment of the data processing method for user personality themes assessment according to the invention.

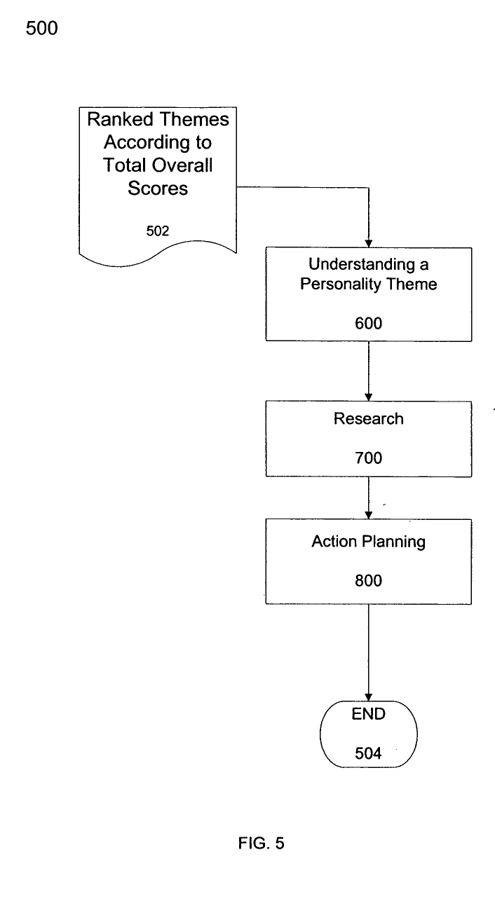

FIG. 6 is a flowchart representing in more detail a preferred embodiment of the understanding personality theme step of the method of FIG. 5.

FIG. 7 is a flowchart representing in more detail a preferred embodiment of the research step of the method of FIG. 5.

FIG. 8 is a flowchart representing in more detail a preferred embodiment of the action planning step of the method of FIG. 5.

FIG. 9 is a schematic representation for secure user inputs of an embodiment of the invention using the Internet, including secure online payment for use of the method.

FIG. 10 is a flow chart representing in more detail secure user identification of the embodiment of FIG. 9.

FIG. 11A is an example of the Values array for organizing and recording the data from the user's Values Assessment for the Career Profile according to the present invention practiced by a user following the manual, card sort embodiment and Elevations™ Workbook.

FIG. 11B is an example of the Skills array for organizing and recording the data from the user's Skills Assessment for the Career Profile according to the present invention practiced by a user following the manual, card sort embodiment and Elevations™ Workbook.

FIG. 11C is an example of the Careers array for organizing and recording the data from the user's Careers Assessment for the Career Profile according to the present invention practiced by a user following the manual, card sort embodiment and Elevations™ Workbook.

FIG. 11D is an example of the Personality array for organizing and recording the data from the user's Personality Assessment for the Career Profile according to the present invention practiced by a user following the manual, card sort embodiment and Elevations™ Workbook.

FIG. 12 is an example of the Scoring Sheet array for illustrating key patterns in, and totaling the data from, the user's Career Profile data input according to the present invention practiced by a user following the manual, card sort embodiment and Elevations™ Workbook.

### DETAILED DESCRIPTION OF THE INVENTION

Reference will now be made to an implementation consistent with the present invention as illustrated in the accompanying drawings. Wherever possible, the same reference numbers will be used throughout the drawings and the following description to refer to the same or like parts. Introduction Generally, methods and systems consistent with the present invention provide the user with a tool that integrates the career-related criteria comprising the basic elements of career self-assessment (values, skills, interests, and personality) with research, decision-making and action planning. It provides an integrated solution for employees, job seekers, homemakers and students looking for career direction or considering a career change.

An embodiment of the present invention comprises a data processing system, further comprising a memory storage device for maintaining a description of a plurality of value sets, skill sets, career interests sets, personality theme sets, and storing a plurality of user assessments of the various sets according to the method of the present invention. A processor is coupled to the memory storage device, and is operative to read the description of the value sets, skill sets, career interests sets, personality theme sets, and user assessments of these various sets. The processor is further operative to display the value sets, skill sets, career interests sets, personality theme sets, and prompts relating to the method of the present invention to the user. The processor then generates sequential user prompts relating to the method of the present invention, displays the prompts to the user, retrieves user inputs in response to the prompts, correlates and scores user inputs, determines the user's career assessment result from the user inputs, and provides an overall career assessment result based upon the user inputs. The data processing system securely reads and stores assessment responses from each of the user. It further securely accepts users into the system. It also securely processes the collection and receipt of user fees. The data processing system directs user interest for additional information to a selected data base. It provides securely generated and printed overall career assessment results for each user and the memory for securely storing at least each user's inputs and career assessments.

Creating a Career Profile Based Upon Summarized Career-Related Criteria

Values Assessment

The values assessment portion of the method of the present invention comprises the steps of first finding the three hierarchy cards marked, Highest, Moderate, and Lowest. Next, the user locates the Values cards. At least forty (40) Values cards are provided by the preferred embodiment of the present invention. As each card is successively read and evaluated by the user along general parameters of importance, motivation, and satisfaction to the user, the user then sorts the Values cards into three stacks: one stack for the user's determined Highest Values; one stack for the user's determined Lowest Values; and the remaining cards for the user's determined Moderate Values.

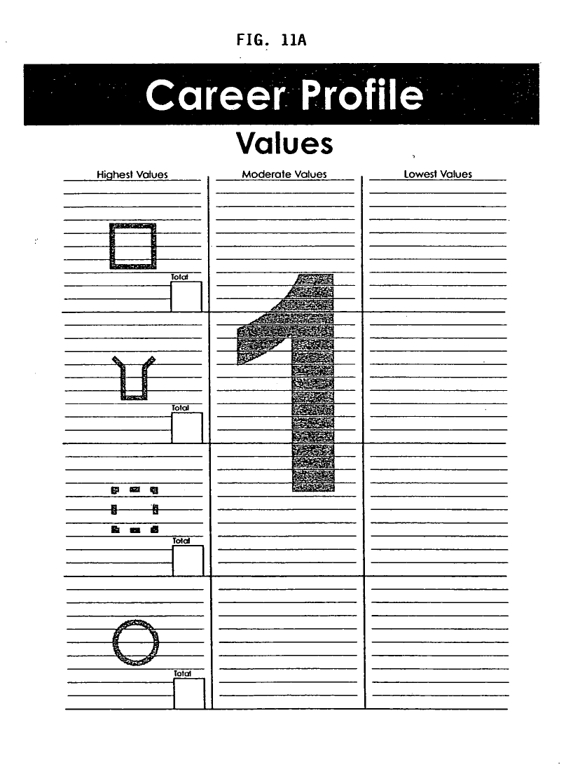

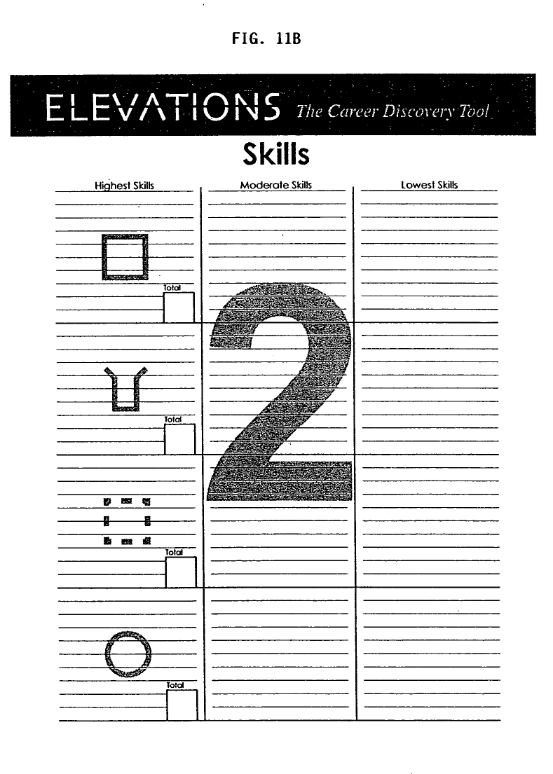

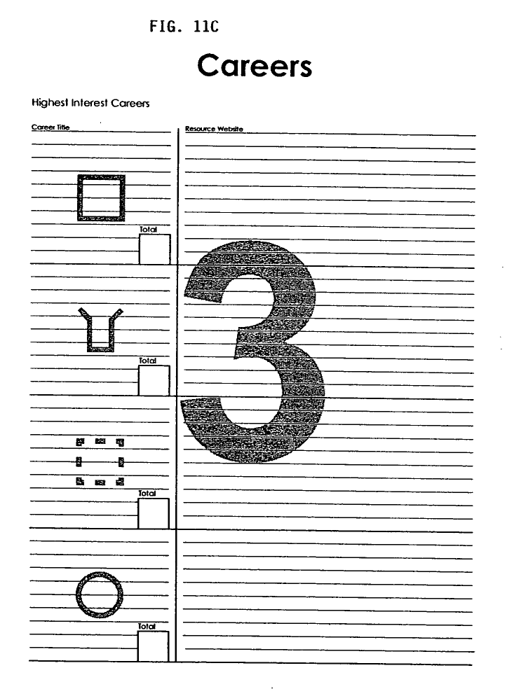

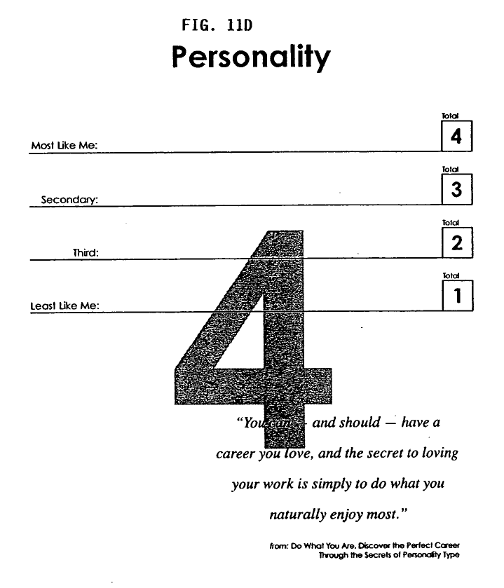

Once the user has completed sorting the cards, the cards are organized into stacks by the colored symbol in the center of the card, according to the method of the invention set forth in the accompanying Elevations™ workbook. The Elevations™ workbook provides the user with a Career Profile recording sheet which comprises a four row by three column values array, FIG. 11A, a four row by three column skills array, FIG. 11B, a four row by two column careers array, FIG. 11C, and a four row by one column personality array, FIG. 11D, wherein each of the values, skills, and careers array rows are organized by a distinct personality theme consisting of organizer, liberator, facilitator, and innovator, whereby each such array presents the four personality themes, wherein the values and skills array columns are organized by hierarchies consisting of highest, moderate, and lowest whereby each array presents the three hierarchies, wherein the careers array column consist of highest interest careers and resources, and wherein the personality for rows consist of most like me, secondary, third, and least like me.

The results are then recorded in the values array section of the user's Career Profile recording sheet, FIG. 11A, provided in the Elevations™ workbook with one point assigned for each of the user's highest values. The user's score for each symbol is then totaled in the box provided.

In electronic embodiments of the present invention, Elevations™ workbook instructions, the Career Profile recording sheet, score recording and totaling steps throughout the method of the invention are automated by the software of a data processing system comprising a memory storage device and a processor coupled thereto.

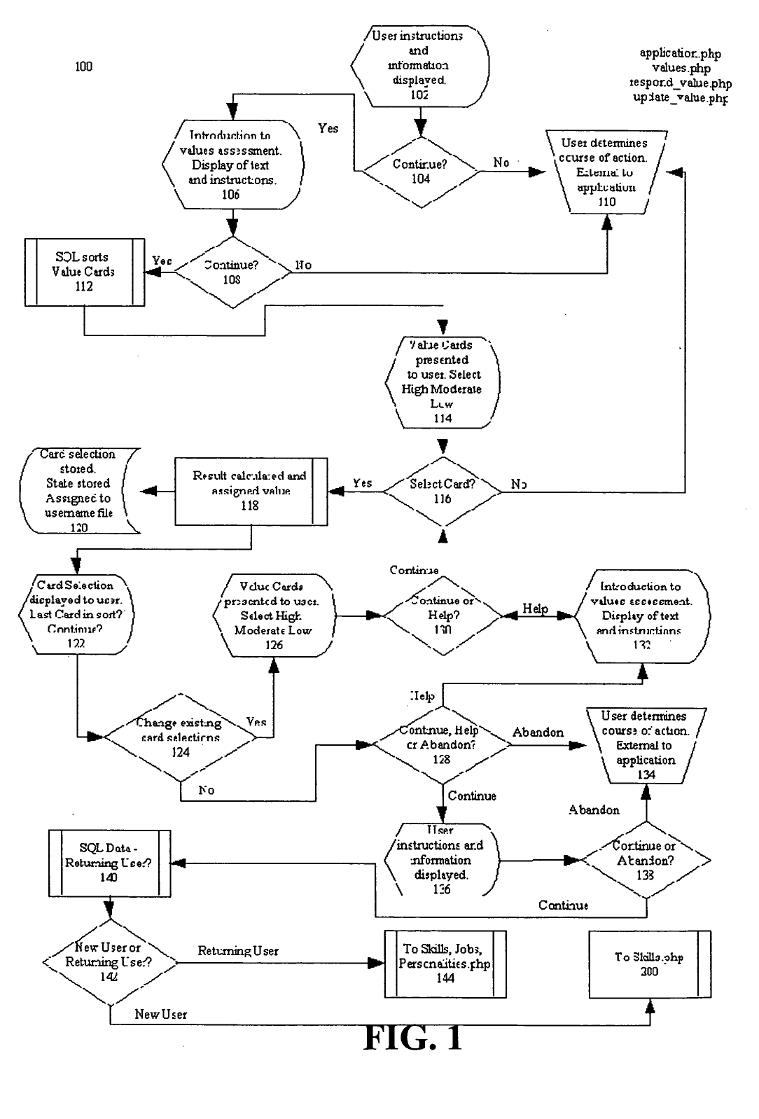

With the foregoing in mind, the detailed operation of user values assessment according to an embodiment of the invention using a data processing system comprising a memory storage device and a processor coupled thereto is depicted in FIG. 1. User instructions and information are displayed 102 and 136 on one or more display terminals, and the user is allowed to continue 104 to introduction of values, display of text and instructions 106 or user determination of course of action external to the application 110. If the user elects to continue 108, value cards are randomly sorted 112 and presented one at a time to the user to select as high, moderate, or low interest 114 according to the user's personal preferences. After the user so selects each card, a result is calculated and assigned a value 118, the value is stored and assigned to the username file 120.

Remaining values cards selection are displayed to the user through the last card in the sort 122, throughout which the user selects each value as high, moderate, or low 126 and to continue or seek help 130. The user is allowed to change existing card selections 124, continue the values assessment steps, or abandon the values assessment steps 128 and 138. User abandonment allows the user to determine a course of action external to the application 134. Help introduces to user to values assessment text and instructions 132 provided by the method. A user returning to the values assessment after abandonment 140 completes the assessment and is then provided with the opportunity 142 to proceed to the skills, career interests, and personalities assessments 144. A new user is directed to the skills assessment 200.

Skills Assessment

At least sixty-four (64) Skills cards are provided by the preferred embodiment of the present invention. Using the Highest, Moderate, and Lowest cards, the user sorts the Skills cards in the same manner as the Values cards, i.e., one stack for the user's perceived Highest Skills, and one for the user's perceived Lowest Skills. The remaining cards reflect the user's perceived Moderate Skills. As the user proceeds through the selection of their perceived skills, the user considers their respective motivation to use each skill and focuses on the skills that they want to use, even if the user still needs to develop those talents. As the user makes their selections, they are mindful that skills can be acquired in both personal and work-related activities. Once the user has completed sorting the cards, they organize each stack by the colored symbol in the center of the card and record their results in the Skills array section of their Career Profile recording sheet, FIG. 11B. One point is assigned for each of their highest skills and their score for each symbol is totaled in the box provided. Skills selected on appeal without experience are recorded to help set future developmental goals for the user.

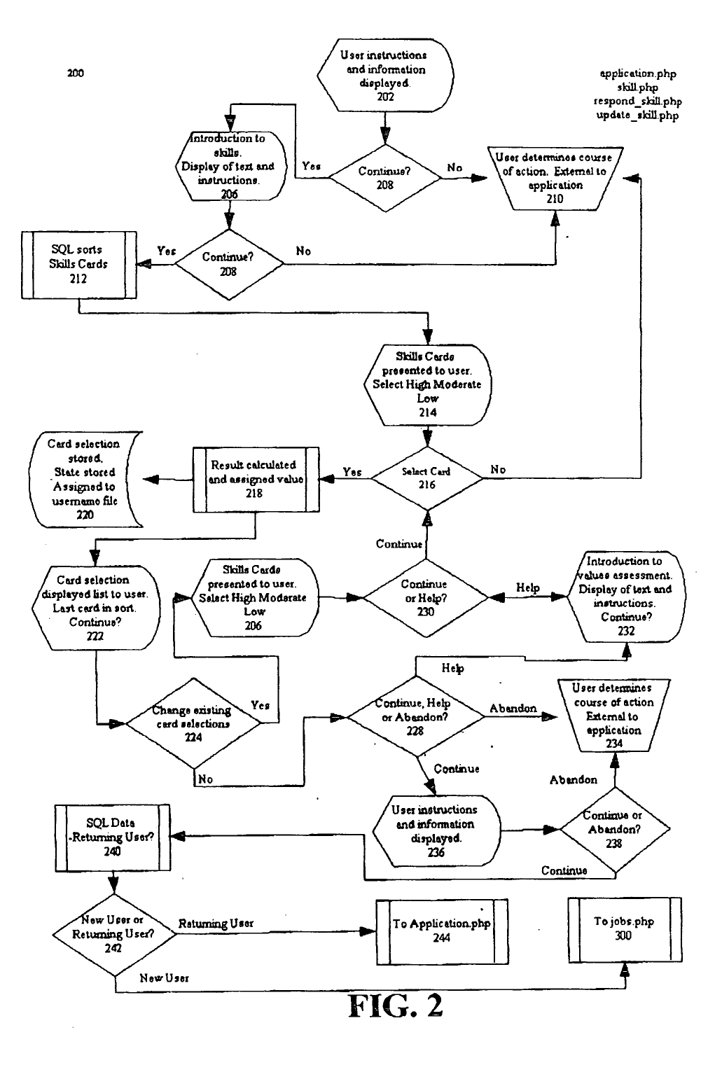

With the foregoing in mind, the detailed operation of user skills assessment according to an embodiment of the invention using a data processing system comprising a memory storage device and a processor coupled thereto is depicted in FIG. 2. User instructions and information are displayed 202 and 236 on one or more display terminals, and the user is allowed to continue 204 to introduction of skills, display of text and instructions 206 or user determination of course of action external to the application 210. If the user elects to continue 208, value cards are randomly sorted 212 and presented one at a time to select as high, moderate, or low interest 214 to the user. After the user so selects each card, a result is calculated and assigned a value 218, the value is stored and assigned to the username file 220.

Remaining skills cards selection are displayed to the user through the last card in the sort 222, throughout which the user selects each value as high, moderate, or low 226 and to continue or seek help 130. The user is allowed to change existing card selections 224, continue the skills assessment steps, or abandon the skills assessment steps 228 and 238. User abandonment allows the user to determine a course of action external to the application 234. Help introduces to user to skills assessment text and instructions 232. A user returning to the skills assessment after abandonment 240 completes the assessment and is then provided with the opportunity 142 to proceed to the application assessment 244. A new user is directed to the career interests assessment 300.

Career Interest Assessment

At least one hundred sixty (160) Careers cards are provided by the preferred embodiment of the present invention. The career interest assessment steps of the present invention commence by placing or arranging the Careers cards in front of user with the career title facing the user. The other side of each card contains a brief description of the work and reference to a website for further information about the career, as well as related careers that might help the user prepare for it by building transferable skills and familiarity with the industry. Using the Highest, Moderate, and Lowest cards, the user sorts the Careers cards the same way as the Values and Skills cards were sorted. The results of the sorting yield one stack for the user's Highest Interest Careers and one stack for the user's Lowest. The remaining cards reflect the user's Moderate Interest Careers.

During the assessment process, if the user needs more information to make a decision on a career, the card is turned over. Past experiences or duties performed similar to those on the card are considered along with the level of satisfaction or reward the user would derive from doing this type of work, and how the user thinks their talents might match the position requirements are evaluated as part of the assessment.

Once the user has completed sorting the cards, their Highest Interest Careers stack is organized by the colored symbol in the center of the cards and their results recorded in the Careers array section of their Career Profile recording sheet, FIG. 11C. One point for each of their highest careers is assigned and their score for each symbol is totaled in the box provided. Moderate Interest or Lowest Interest selections need not be recorded. However, the user may want to take a second look at their Moderate Interest selections to see if there are any careers they would like to make note of, or move to their Highest Interest stack. If the user cannot fit all their career interests on the Career Profile, they record their selections on the back of the sheet.

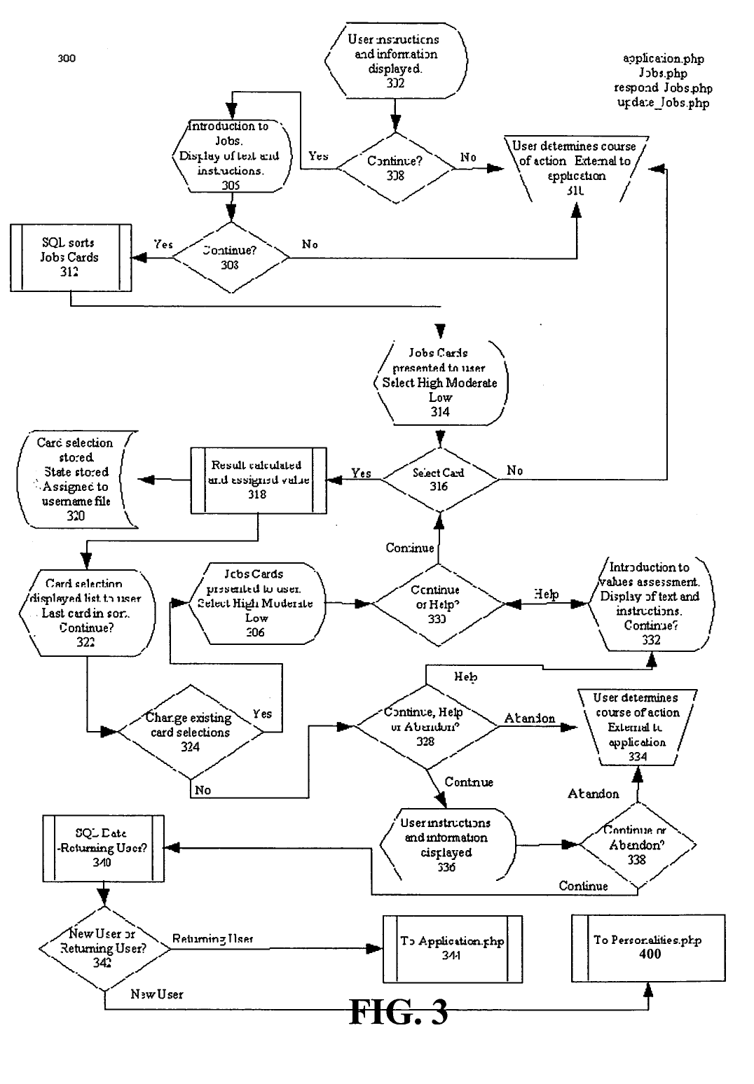

With the foregoing in mind, the detailed operation of user career interests assessment according to an embodiment of the invention using a data processing system comprising a memory storage device and a processor coupled thereto is depicted in FIG. 3. User instructions and information are displayed 302 and 336 on one or more display terminals, and the user is allowed to continue 304 to introduction of career interests, display of text and instructions 306 or user determination of course of action external to the application 310. If the user elects to continue 308, value cards are randomly sorted 312 and presented one at a time to select as high, moderate, or low interest 314 to the user. After the user so selects each card, a result is calculated and assigned a value 318, the value is stored and assigned to the username file 320.

Remaining career interests cards selection are displayed to the user through the last card in the sort 322, throughout which the user selects each value as high, moderate, or low 326 and to continue or seek help 330. The user is allowed to change existing card selections 324, continue the career interests assessment steps, or abandon the career interests assessment steps 328 and 338. User abandonment allows the user to determine a course of action external to the application 334. Help introduces to user to career interests assessment text and instructions 332 provided by the invention. A user returning to the career interests assessment after abandonment 340 completes the assessment and is then provided with the opportunity 342 to proceed to the skills, career interests, and personalities assessments 344. A new user is directed to the personality themes assessment 400.

Personality Themes Assessment

The personality themes assessment of the present method comprises the initial step of the user reading the four Personality Themes cards and ranking them from most to least like themselves. The user can relate to aspects of all four cards in differing degrees. The user then rank their personality themes in the Personality section of their Career Profile recording sheet, FIG. 11D. To complete the next step and score their results, the user assigns four points to the personality theme recorded as “Most Like Me,” three points for “Secondary,” two points for “Third,” and one point for “Least Like Me.” These totals, along with totals from their Values, Skills, and Career Interests, are used to complete the next step, scoring their results.

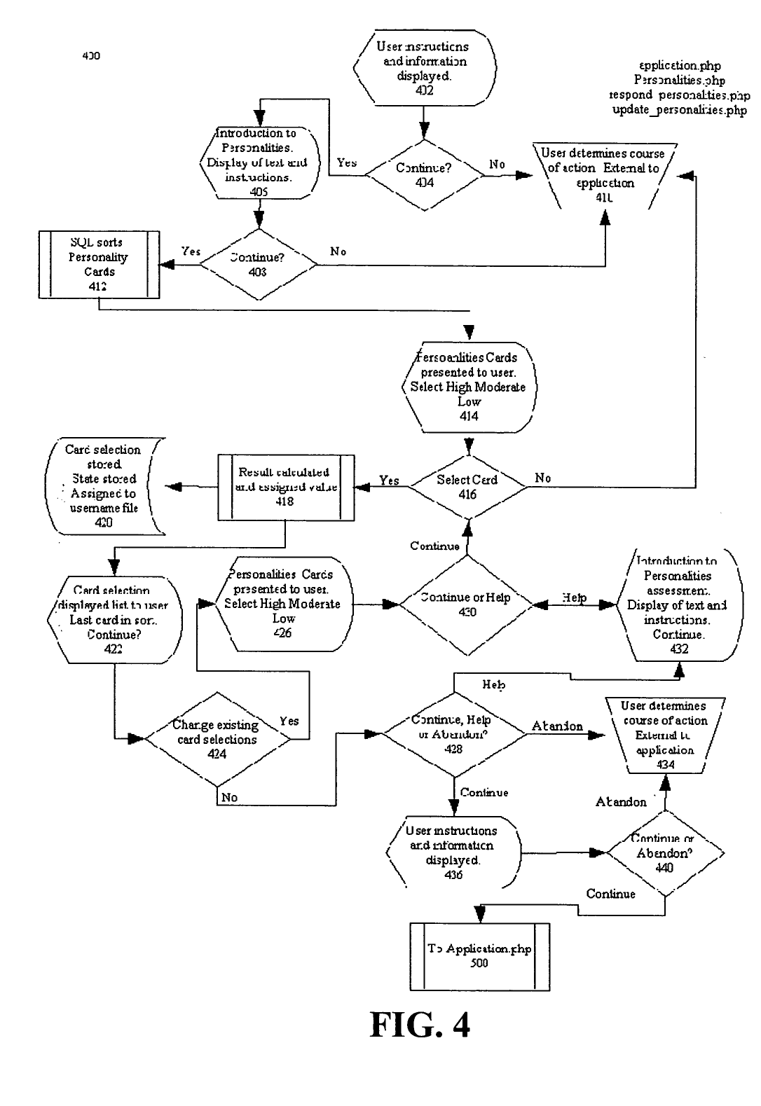

With the foregoing in mind, the detailed operation of user personality themes assessment according to an embodiment of the invention using a data processing system comprising a memory storage device and a processor coupled thereto is depicted in FIG. 4. User instructions and information are displayed 402 and 436 on one or more display terminals, and the user is allowed to continue 404 to introduction of personality themes, display of text and instructions 406 or user determination of course of action external to the application 410. If the user elects to continue 408, value cards are randomly sorted 412 and presented one at a time to select as high, moderate, or low interest 414 to the user. After the user so selects each card, a result is calculated and assigned a value 118, the value is stored and assigned to the username file 420. Remaining personality themes cards selection are displayed to the user through the last card in the sort 422, throughout which the user selects each personality theme as high, moderate, or low 426 and to continue or seek help 430. The user is allowed to change existing card selections 424, continue the personality themes assessment steps, or abandon the personality themes assessment steps 428. User abandonment allows the user to determine a course of action external to the application 434. Help introduces to user to personality themes assessment text and instructions 432. A user continuing the assessment is provided user instructions and information 436 and again allowed to continue or abandon the assessment 440. User abandonment allows the user to determine a course of action external to the application 434. Returning to the personality themes assessment after abandonment 440 completes the assessment and is then provided with the opportunity to proceed to assessment of ranked themes according to the user's overall scores 500.

Results Scoring

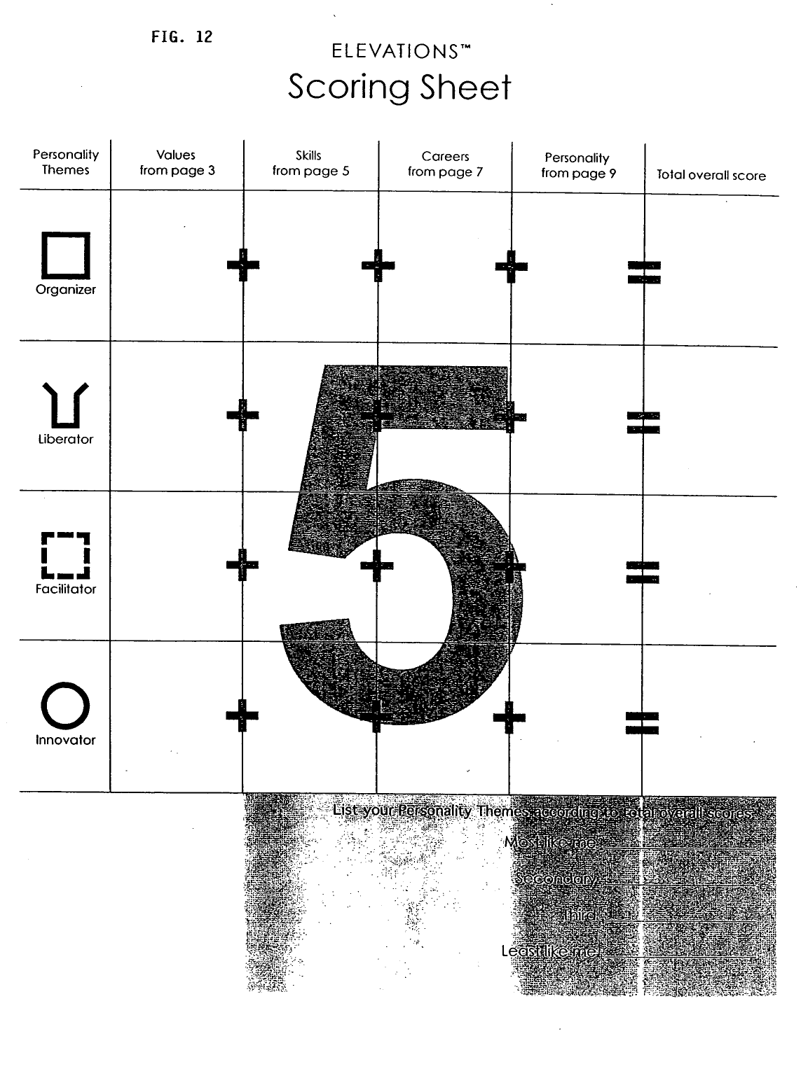

Each card sort, by itself, provides information about the user's career preferences and capabilities and points towards rewarding career choices. But the key to successful career management is understanding the unique characteristics shaped by the user's values, skills, career interests, and personality themes. In order to discover the key patterns in the user's Career Profile, the user completes the Scoring Sheet, FIG. 12. As depicted in FIG. 12, the Scoring Sheet comprises a four row by six column array wherein each row represents a distinct personality theme consisting of organizer, liberator, facilitator, and innovator, and wherein columns consist of personality themes, values, skills, careers, personality, and total overall score.

The user's Career Profile recording sheet results are transferred to the Scoring Sheet. The total points for each personality theme symbol are added up in the right-hand column. The symbol correlating to the user's highest number indicates their dominant personality theme. The symbol for their second highest number indicates their secondary theme, which often works together with the dominant theme to define many work capabilities and preferences. The third and fourth-ranked themes may describe less obvious aspects or traits not related to as strongly. In this fashion, they represent a user's “least preferred” personality characteristics.

Results scoring is manually entered on the Scoring Sheet for the embodiment of the method of the present invention comprising the Elevations workbook and manual card sort kit. Embodiments of the method of the present invention comprising a memory storage device and a processor coupled thereto provide means for securely generating and printing each user's overall career assessment results, including results scoring, and memory for securely storing at least each user's assessment inputs and result.

Understanding a Personality Theme

The next steps in the method of the present invention provides the user with more detailed information about their unique personality preferences or temperament. The method of the present invention draws from Carl Jung's personality and psychological types theory as well as David Keirsey's work in temperament theory. The user considers four personality theme descriptions: organizer, liberator, facilitator and innovator, and decides whether a dominant theme—strong, Most-Like-Me is found, or whether two or more (Secondary) personality themes are found. By considering whether personality descriptions match their career profile results assists the user to understand:
How they communicate;
Their leadership and management tendencies;
Their team member tendencies;
How their Most-Like-Me and Secondary themes work together; and
Career development tips customized for their personality theme.

The user's examination of their personality themes begins by the user reviewing the Personality Snapshots provided by the method of the present invention. Attention is paid as to which of the descriptions match their Career Profile results. The user will read the entire personality profile provided by the method of the present invention to learn more about their personality preferences.

If the user has a clear preference for one of the four personality themes, they can focus on career opportunities that align with their theme by reading the description of their theme provided by the method of the present invention.

If the user has a “combo package” result, they are directed to read their “Most-Like-Me and Secondary” profile. It is common for people to strongly relate to two personality themes. Under such circumstance, their career will need to integrate elements from both themes. They may also want to consider a portfolio career balancing their needs with leisure activities and community service.

For example, an individual may prefer a career that emphasizes Organizer skills, but they are driven by Facilitator values. This is a great clarification that will assist the user in your career research and interviewing. In this case, they will be seeking an organization or opportunity that culturally supports Facilitator values. In their interviews they can ask specific questions to ensure that their values will be supported. They then look at the job description to ensure that Organizer skills are required. If such dual needs are mutually satisfied, the user has found the perfect fit.

A user with preferences reflected across all four themes is likely to be most satisfied in a career that is highly flexible and diverse. This will allow such an individual to express their varied interests and utilize the full range of their talents.

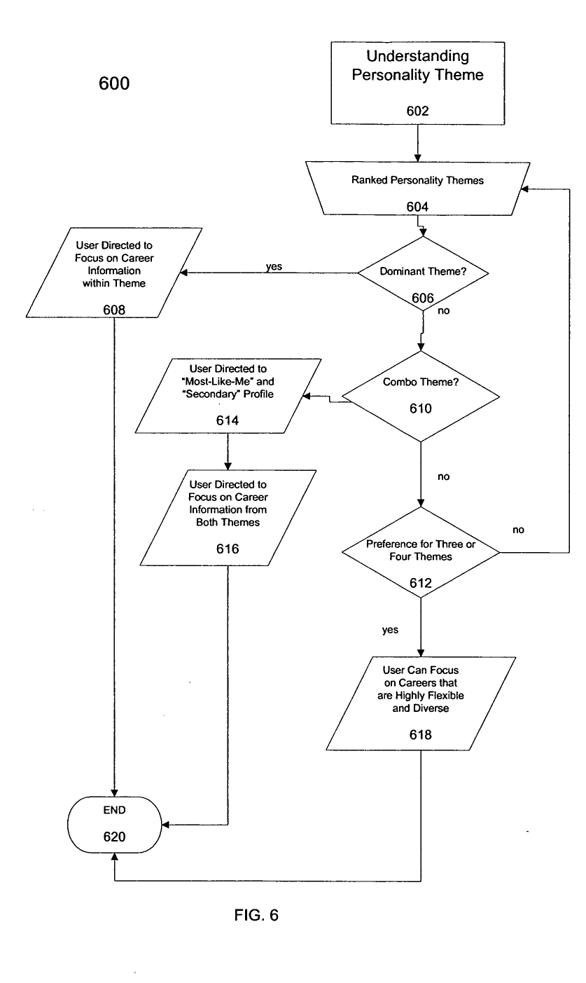

With the foregoing in mind, the detailed operation of user personality themes assessment 600 according to an embodiment of the invention using a data processing system comprising a memory storage device and a processor coupled thereto is depicted in FIG. 6. To initiate the steps for understanding a user's personality theme 602, the user's ranked personality themes 604 are examined. For user dominant themes 606, the user is directed to focus on career information within the dominant themes 608 presented by the invention. If no dominant themes are presented, the user examines whether combination themes are presented 610. A user with combination themes is directed to “most-like-me” and “Secondary” profile 614, and then to focus on career information from both themes 616. A user without either dominant or combination themes, is queried as to whether they have a preference for three or four themes 612. A positive response to this question allows the user to focus on highly diverse or flexible careers 618. Once the user has positively responded to one of the three possible theme outcomes and completes the focus step associated with respective the outcome, the understanding personality steps of the invention are completed 620. A user without any positive response to one of the three possible theme outcomes is directed back to the ranking step 604 wherein the process is repeated to selection of theme outcome and completion of understanding the user theme steps.

Action Planning and Research

Once the user completes the Career Profile section of the method of the present invention, gains a better understanding of their unique blend of personality themes, and reflects on what they discovered about themselves regarding these characteristics, the next step is to develop an Action Plan to elevate their career.

Consider Career and Industry

The user reviews their Career Profile and revisits the careers that attracted them when completing the Careers card sort. In this process, they identify careers that they would like to learn more about. The user lists at least ten career interests, or options. Then, to the right of each career option, the user considers in which industry they would like to perform the particular career option position. A list of industries is provided for the user by the method of the present invention.

Positions like sales, office administration, or management, for instance, can all be done in a variety of industries, or settings, such as banking, retail, insurance, telecommunications, health care, or the like. A doctor could work in a local hospital or the World Health Organization. A tree trimmer could work for a nursery, a local utility, or local government. Almost all careers can be found in both the public and private sectors. The action planning and research steps of the method of the present invention allows the user to select career fields to learn about and match work environments to each considered career field consistent with the user's temperament.

At this juncture, the user is encouraged not to limit their options to the careers found in the Careers card sort, but instead to be open to many other kinds of jobs. The user is further encouraged to add their own ideas for career options as they gain insight and knowledge about the variety of opportunities available.

Research Resources

The user is encouraged to conduct primary and secondary research relating to career interests. Primary research includes direct communication with individuals in the career or industry of interest. Secondary research includes gathering information from books, Internet sites, or directories.

The user is directed to begin with secondary research, as once the user develops a good foundational understanding of their next potential position or promotional opportunity the next logical step is to communicate with persons performing the position through informational interviews. The method of the present invention provides numerous resources for the user to employ in obtaining informational interviews, including web site addresses for Career Selection/Evaluation, Business and Industry Directories, Industry Research, as well as career sites. From this wealth of background informational sources, the user can decide whether to exclude the option from their list or proceed with primary research.

The method of the present invention further provides user resources for completing their primary research. Users are directed to suggestions on finding people to contact. Guidance is provided to the. user to conduct an informational interview through friends, within a networking function, or by cold-calling. Sample questions to be included in an informational interview as well as how to conduct such an interview are included in the method of the present invention.

Prioritize what is Important

Each career option and job opportunity presents positive and negative aspects. As the user proceeds with their research, they are reminded to consider what is important to them. When a decision point is reached, such as choosing a college major or accepting a job transfer, the user will be able to analyze if the step they are taking matches their personal and professional priorities.

Top Values

The user lists at least three and up to six of the highest values they recorded on their Career Profile. Then, these values are ranked in order of importance to user. Values not represented in the card sort, if they are highly important to the user, are listed. The top three are noted.

Top Skills

The user lists at least three and up to six of the highest skills they recorded on their Career Profile. Then, these skills are ranked in order of importance to the user. Skills not represented in the card sort, if they are talents the user identifies as being desirable in their next job, are listed. The top three highest skills are noted.

Rank Career Options Against Priorities

Using the rating chart provided by the method of the present invention, the user lists their top three values and top three skills in descending order, from one to six. These ranked characteristics are entered in the Priority boxes numbered 1-6 on the rating chart. Next, the user considers which of the six items is absolutely most important to them, and continues the ranking steps until all six have been entered according to the user's preferences. For instance, the user might consider Meaningful Work as a value is more important than anything else, including other values and skills. Or, the user may decide that the opportunity to Teach/Instruct as a skill is the one aspect they seek above all others in their next position.

Next, the user lists their top ten career options in the Career Options column. The user then rates the “fit” of each career, assigning values from 1-4 to indicate how much opportunity the career has to satisfy each priority (1=none; 2=little; 3=some; 4=great). Research Resources provided by the method of the present invention assists to user to learn more about a particular field if the user is uncertain whether a particular career will satisfy their priorities.

Then, the user adds the totals to see which career options best satisfy their values and skills priorities. This ranking process is enhanced when the user actively gathers information and researches the career options selected. In this manner, error caused by making assumptions about career options is minimized. The user is further encouraged to discuss the career options with people engaged in the particular options selected, thus ending the research steps of the invention.

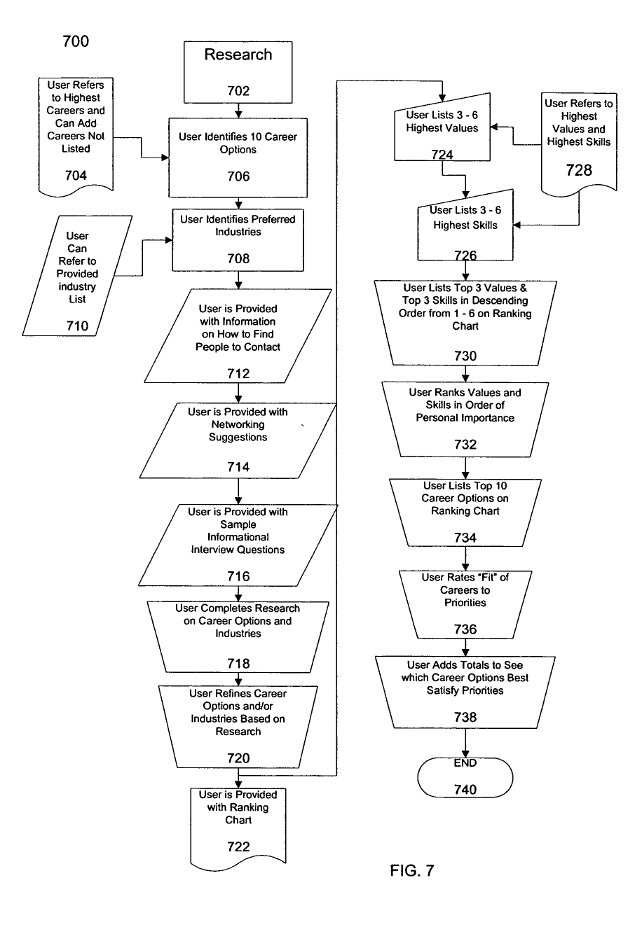

With the foregoing in mind, the detailed operation of user research 700 following the understanding steps 600 according to an embodiment of the invention using a data processing system comprising a memory storage device and a processor coupled thereto is depicted in FIG. 7. The user identifies ten career options 706 using the highest careers listed and other careers of interest 704. Next, the user identifies preferred industries 708, using the reference list of industries provided by the method 710. The user is then provided with information on how to find contact persons 712, networking suggestions 714, and sample informational interview questions 716. The user next completes research on career options and industries 718, which are then refined 720. Using a ranking chart provided by the invention 722, the user then lists 3-6 values 724 and 3-6 highest skills 726, referring to the user's highest values and skills results 728. The user then lists their top three values and top three skills in descending order from 1-6 on the ranking chart 730. Next, the user ranks values and skills in order of personal importance 732. Next the user lists their top ten career options on the ranking chart 734. The user then rates the “fit” of careers to priorities 736. The totals are added to identify which career options best satisfy the user priorities 738, thus ending the research steps 740.

Overcome Barriers

Connecting Career Profile assessment results with the appropriate career opportunities is a critical step in the method of the present invention. At this juncture, the user has several relatively significant ideas to further explore. Reaching goal identified by the user in this process may or may not require an entire career change. At this stage of the career exploration process, the user must consider broader issues such as their salary needs, education and training requirements of their selected career options, the potential for career enrichment or promotional opportunities with their present employer, and, of course, their willingness to make a total career change.

Creating an Action Plan to Implement the Career Goals

The user next creates an action plan using an Action Plan format provided by the method of the present invention to help organize and achieve the career goals identified by the user. The Action Plan is organic, and designed to be adjusted as it is being developed. For the manual method of the present invention, the user is encouraged to use a pencil for Action Plan inputs. The user first writes their name and the current date at the top of their Action Plan.

Next, the user writes their career goal in the space provided. The user selects the career option that meets the greatest number of their requirements based upon the closest match to their values, skills and personality themes. Additionally, the career option must be manageable and not too risky given the user's personal and professional circumstances. The user is encouraged to evaluate intermediate steps towards their overall career goal. For example:
1. Taking a promotional exam for a supervisor-level position.
2. Seeking a job as an accountant in the manufacturing industry.
3. Taking flying lessons to become an airline pilot.

In the second column of the Action Plan, the user lists the steps they will need to take to achieve their goal. These listed steps are reviewed and then the Priority Level column is used to rank their importance and the order of completion to determine the user's first action steps to realize the career goal.

The user then lists the resources that will be needed. Time spent considering the resources needed may generate additional steps that need to be taken. For example, the user may find that they must visit a Financial Planner in order to determine how soon certain steps within the action plan can be taken. If so, the user would add, “visit a Financial Planner” as one of their intermediate action steps.

The user then sets completion dates for each action step. The user makes certain that the completion dates are realistic and achievable.

The completed Action Plan is posted in a convenient location to frequently remind the user of their goals. As each item is accomplished, it is checked off the Action Plan.

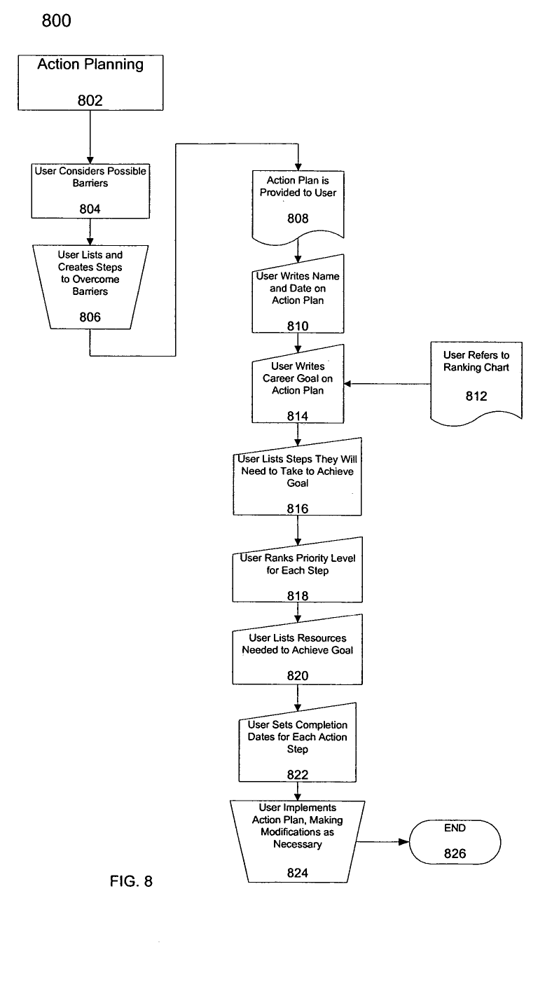

With the foregoing in mind, the detailed operation of user action planning 800 following the research steps 700 according to an embodiment of the invention using a data processing system comprising a memory storage device and a processor coupled thereto is depicted in FIG. 8. Action planning 802 commences with the user considering the possible barriers 804, and then creating lists to overcome the barriers 806. An action plan is provided to the user 808, and is personalized by the user's name and the date the plan was generated 810. Referring to the ranking chart provided by the invention 812, the user enters their career goal on the action plan 814. Next, the user lists steps necessary to achieve their goal 816. A priority level is assigned each step necessary to achieve their goal, and each level is ranked by the user 818. Resources needed to achieve the goal are listed by the user 820. Completion dates are then set by the user 822 for each action step. The action plan is then implemented by the user who modifies the plan as necessary to achieve the goals and objectives defined thereby 824, thus ending the action planning portion of the present invention 826.

An embodiment of the present invention uses the multimedia-rich World Wide Web (www) portion of the Internet to access the career self-assessment, research, decision-making and action planning steps. Through a series of inter-active computer screen illustrations the online embodiment further guides and directs the user through the steps of the present invention. For embodiments of the invention using CD-ROM, these resources are disk resident, and are updated for the user on regular intervals.

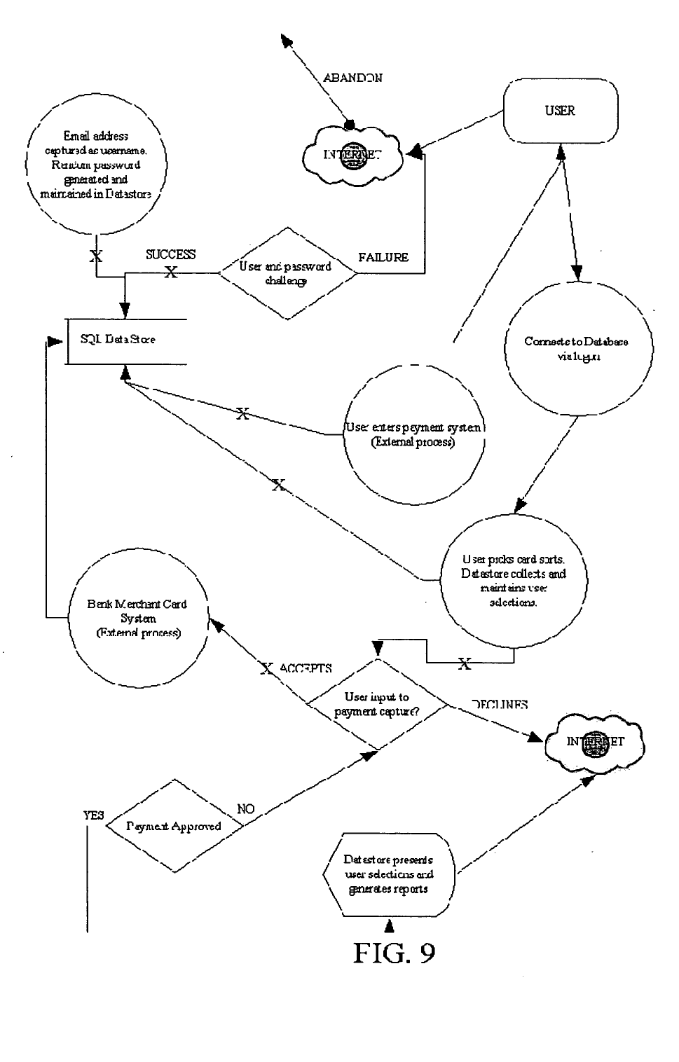

Referring now to FIG. 9, the schematic for secure user inputs including payment 900 begins with the user connecting to the system data base 910. The system captures the user's email address as the user name and a random password is generated and stored in the system memory 980. Successive user access to the system requires successful secure input of the user name and assigned password 975. Payment can be external to the online system, for example by check or subscription 990. Payment can also be made within the online access with user input to payment capture 930 and approval 940 wherein the system presents user selection(s) and generates user reports 950. Accepted payments authorizes payment from an external bank source, such as a bank merchant card, 960 which is stored in the system memory. A paid up user makes their choices according to the method of the present invention, for example electronic card sorts, and the system collects and maintains the user selections 920 which are stored in the system memory 970.

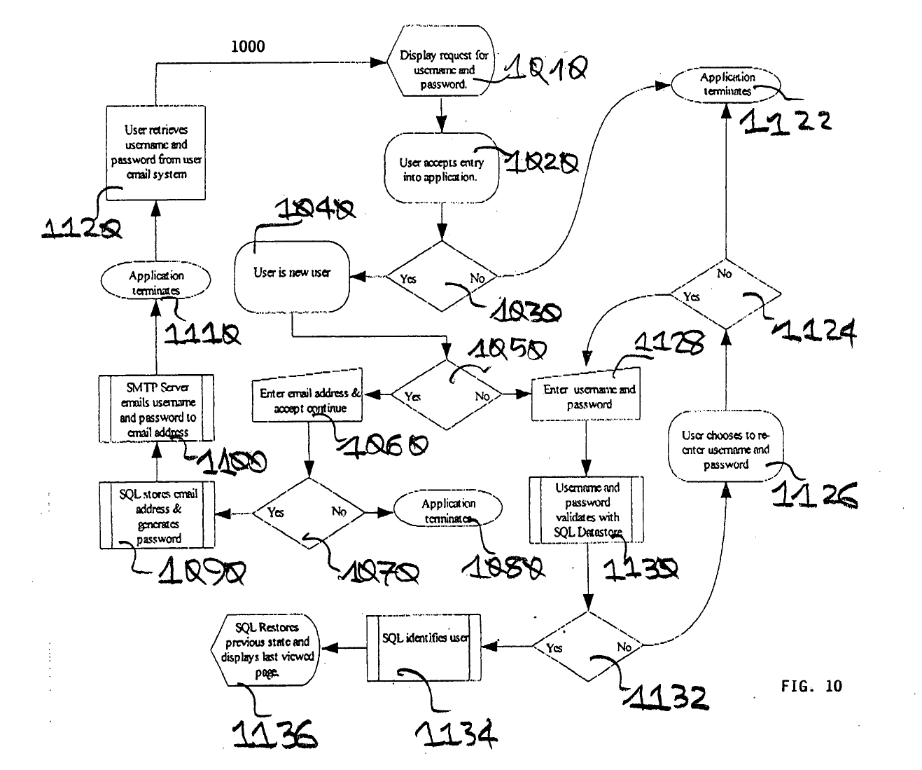

FIG. 10 depicts the secure user name and password creation steps for an embodiment of the present invention using a data processing system comprising a memory storage device and a processor coupled thereto and the Internet. A display request for username and password is presented 1010. Once a user accepts entry into the method of the invention 1020, new users 1040 enter an email address and accept continue 1060. If the user does not accept entry, the application terminates 1122. The new user data is stored in the system memory 1090, and a confirming email containing the user name and password is provided to the new user 1100, and the application terminates 1110. Once the new user retrieves their user name and password from the system's confirming email 1120, the new user is prepared to use the invention.

Existing users enter their user name and password 1128 which is validated by the system 1132. Invalid entries are presented to the user for re-entry of correct user data 1126. Invalid data terminates the application 1122. Once a user is identified, the invention restores the previous state of the invention and displays the last viewed page 1136.

For an embodiment of the invention using a processing unit and memory storage device with CD-ROM, these user name and password creation steps would be similar, except for the use of confirming email.

A latitude of modification, change and substitution is intended in the foregoing disclosure, and in some instances some features of the invention will be employed without a corresponding use of other features. Accordingly, it is appropriate that the appended claims be considered broadly and in a manner consistent with the spirit and scope of the invention herein.

1. A method for an improved career discovery tool, the method comprising the steps of:
providing a career profile recording sheet;
completing a career profile;
understanding personality themes; and
action planning and research.

2. The method of claim 1, wherein the step of completing a career profile further comprises the step of assessing values.

3. The method of claim 1, wherein the step of completing a career profile further comprises the step of assessing skills.

4. The method of claim 1, wherein the step of completing a career profile further comprises the step of assessing career interests.

5. The method of claim 1, wherein the step of completing a career profile further comprises the step of assessing personality themes.

6. The method of claim 1, wherein the career profile recording sheet comprises a four row by three column values array, a four row by three column skills array, a four row by two column careers array, and a four row by one column personality array, wherein each of the values, skills, and careers array rows are organized by a distinct personality theme consisting of organizer, liberator, facilitator, and innovator, whereby each such array presents the four personality themes, wherein the values and skills array columns are organized by hierarchies consisting of highest, moderate, and lowest whereby each array presents the three hierarchies, wherein the careers array column consists of highest interest careers and resources, and wherein the personality array rows consist of most like me, secondary, third, and least like me.

7. The method of claim 2, wherein the step of assessing values further comprises the steps of;
providing an established value set;
establishing a hierarchy of values consisting of highest, moderate, and lowest;
considering each value from the values set;
placing each considered value into one of the three hierarchy of values until all values are so placed;
organizing the hierarchy of values by personality theme;
recording the results on the career profile recording sheet.

8. The method of claim 3, wherein the step of assessing skills further comprises the steps of;
providing an established skill set;
establishing a hierarchy of skills consisting of highest, moderate, and lowest;
considering each skill from the skills set;
placing each considered skill into one of the three hierarchy of skills until all skills are so placed;
organizing the hierarchy of skills by personality theme;
recording the results on the career profile recording sheet.

9. The method of claim 4, wherein the step of assessing careers further comprises the steps of;
providing an established career set;
establishing a hierarchy of careers consisting of highest, moderate, and lowest;
considering each career from the careers set;
placing each considered career into one of the three hierarchy of careers until all careers are so placed;
organizing the highest interest careers by personality theme;
recording the results on the career profile recording sheet.

10. The method of claim 5, wherein the step of assessing personality themes further comprises the steps of;
providing an established set of four personality themes;
considering each personality from the personality themes set;
ranking each personality theme according to the user's overall impressions of the theme in relation to the user's self-assessment;
assigning four points to the personality theme the user deems to be most like themselves;
assigning three points to the personality theme the user deems to be secondarily most like themselves;
assigning two points to the personality theme the user deems to be thirdly most like themselves;
assigning one point to the personality theme the user deems to be the least like themselves; and
scoring the results on the career profile recording sheet.

11. The method of claim 10, wherein the personality themes consist of organizer, liberator, facilitator, and innovator.

12. The method of claim 11, wherein completing a career profile further comprises the steps of:
providing a scoring sheet comprising a four row by six column array wherein each row represents a distinct personality theme consisting of organizer, liberator, facilitator, and innovator, and wherein columns consist of personality themes, values, skills, careers, personality, and total overall score;
transferring the results for values assessment from the career profile recording sheet to the scoring sheet values column;
transferring the results for skills assessment from the career profile recording sheet to the scoring sheet skills column;
transferring the results for career interests assessment from the career profile recording sheet to the scoring sheet careers column;
transferring the results for the personality themes assessment from the career profile recording sheet to the scoring sheet personality column;
totaling the points for each personality theme row in the scoring sheet total overall score column.

13. The method of claim 12, wherein the step of understanding personality themes further comprises the steps of:
providing personality snapshots;
reviewing descriptions of the personality snapshots;
matching personality snapshot descriptions with career profile results;
ranking personality themes according to dominant, secondary or combination categories; and
focusing on career opportunities consistent with the personality themes ranking.

14. The method of claim 13, wherein the step of action planning and research further comprises the steps of:
providing a roster of a plurality of possible careers within the user's personal personality themes ranking;
providing a roster of a plurality of possible industries within the user's personal personality themes ranking;
providing the user with contact person information within the career and industry rosters;
providing the user with networking suggestions within the career and industry rosters;
providing the user with sample informational interview questions within the career and industry rosters;
providing a ranking chart;
identifying a plurality of possible careers from the career roster;
identifying a plurality of preferred industries from the industries roster;
completing the research on career options and industries; refining the research;
listing user's 3-6 highest values;
listing user's 3-6 highest skills;
listing user's top three values and top three skills in descending order on the ranking chart;
rating user's fit of careers to priorities; and
totaling the results to identify which career options best satisfy user priorities.

15. The method of claim 14, wherein the step of action planning and research further comprises the steps of:
providing an action plan format to the user;
providing the user's name on the action plan format;
providing the current date on the action plan format;
considering possible barriers to achieve user's career goals and objectives;
creating action plan lists within the action plan format to overcome the barriers;
entering the career goals into the action plan from the ranking chart;
listing steps necessary to achieve each career goal;
assigning a priority level to each step necessary to achieve each career goal;
listing resources needed to achieve each step necessary to achieve each career goal;
setting completion dates for each step necessary to achieve each career goal;
implementing the action plan; and
modifying the action plan as necessary to achieve the goals and objectives defined therein.

16. The method of claim 15 wherein the method is practiced using a data processing system comprising:
a memory storage device for maintaining a description of a plurality of value sets, skill sets, career interests sets, personality theme sets, and storing a plurality of user assessments of the various sets according to a predetermined methodology;
a processor coupled to the memory storage device, the processor being operative to:
reading the description of the value sets, skill sets, career interests sets, personality theme sets, and user assessments of these various sets;
display the value sets, skill sets, career interests sets, personality theme sets, and prompts relating to the predetermined methodology to a user;
generate sequential user prompts relating to the predetermined methodology;
display the prompts to the user;
retrieve user inputs in response to the prompts;
correlate and score user inputs;
determine career assessment result from the user inputs, and
provide an overall career assessment result based upon user inputs;
means for securely reading and storing assessment responses from each of the users;
means for securely accepting users into the system; means for securely processing collection and receipt of user fees for the system;
means for directing user interest for additional information to a selected data base;
means for securely generating and printing the overall career assessment result for each user; and
memory for securely storing at least the user inputs, career assessment result for each user.

17. The method of claim 16 wherein the user accesses the data processing system via the Internet.

18. The method of claim 16 wherein means for securely accepting users into the data system and memory storage device further comprises the steps:
system displaying request for user name and password;
user accepting entry into the system;
user entering one of (i) existing user name and password or (ii) new user name and user email address;
system validating user name and password for existing users;
system storing email address in memory storage device and generating password for new users;
system sending the user name and password to the new user via email and terminating the application;
system allowing existing user to re-enter user name and password if either or both are invalid;
system terminating application if existing user fails to enter a valid user name and password on second try;
system identifying existing user entering a valid user name and password; and
system restoring previous method step from memory storage and displaying last viewed page to user.

19. The method of claim 16 wherein securely processing collection and receipt of user inputs including fees for the system further comprises the steps:
user connecting to the database using secure login;
system identifying the user name and password and accepting the user;
user inputting secure payment;
system securely storing user payment;
system approving user as paid up for use of method;
system securely presenting user selections to approved user;
user securely inputting choices according to the method of the invention;
system securely storing user inputs; and
system securely generating and presenting user reports consistent with the method of the invention.

20. The method of claim 16 wherein the user accesses the data processing system via CD-ROM.

21. The method of claim 15 wherein the method is practiced using a kit comprising in combination:
an instructional workbook;
a highest card hierarchy marker;
a moderate card hierarchy marker;
a lowest card hierarchy marker;
the established value set further comprising at least 40 value set cards wherein each value set card provides a separate value characteristic with a colored symbol in the center of the card wherein the colored symbol has a distinct color and symbol relating to one of four personalities consisting of facilitator, innovator, liberator, and organizer;
the established skills set further comprising at least 64 skills set cards wherein each skills set card provides a separate skills characteristic with a colored symbol in the center of the card wherein the colored symbol has a distinct color and symbol relating to one of four personalities consisting of facilitator, innovator, liberator, and organizer;
the established career interests set further comprising at least 160 career interests set cards wherein each career interests set card provides a separate career interests characteristic with a colored symbol in the center of the card wherein the colored symbol has a distinct color and symbol relating to one of four personalities consisting of facilitator, innovator, liberator, and organizer;
the established personality themes set further comprising at four personality themes set cards wherein each personality themes set card provides a separate personality theme consisting of facilitator, innovator, liberator, and organizer; and
whereby the user practices the method using the kit, a manual card sort, and manual results scoring for the completing a career profile step according to the method of the invention.

22. A computer system within a networked environment for an electronic career discovery tool for a plurality of users, the system comprising:
a memory storage device for maintaining a description of a plurality of values sets, skills sets, careers interests sets, personality theme sets, and storing a plurality of user assessments of the various sets according to a predetermined methodology;
a processor coupled to the memory storage device, the processor being operative to:
reading the description of the values sets, skills sets, careers interests sets, personality theme sets, and user assessments of the various sets;
display the values sets, skills sets, careers interests sets, personality theme sets, and prompts relating to the predetermined methodology to a user;
generate sequential user prompts relating to the predetermined methodology;
display the prompts to the user;
retrieve user inputs in response to the prompts;
correlate and score user inputs;
determine career assessment result from the user inputs, and
provide an overall career assessment result based upon user inputs;
means for securely reading and storing assessment responses from each of the users;
means for securely accepting users into the system;
means for securely processing collection and receipt of user fees for the system;
means for directing user interest for additional information to a selected data base;
means for securely generating and printing the overall career assessment result for each user; and
memory for securely storing at least the user inputs, career assessment result for each user.

23. The system of claim 22 wherein means for securely generating and printing the overall career assessment result for each user includes:
means for providing an established set of four personality themes;
means for considering each personality from the personality themes set;
means for ranking each personality theme according to the user's overall impressions of the theme in relation to the user's self-assessment;
means for assigning a predetermined point level to each personality theme the user deems to be most like themselves;
means for assigning a predetermined point level to each personality theme the user deems to be secondarily most like themselves;
means for assigning a predetermined point level to each personality theme the user deems to be thirdly most like themselves;
means for assigning a predetermined point level to each personality theme the user deems to be the least like themselves; and
means for scoring the results.

24. The system of claim 22 wherein personality themes consist of organizer, liberator, facilitator, and innovator.

25. The system of claim 22 wherein means for securely generating and printing the overall career assessment result for each user includes:
means for securely transferring the results for career interests assessment to a scoring sheet;
means for securely transferring the results for values assessment to the scoring sheet;
means for securely transferring the results for skills assessment to the scoring sheet;
means for securely transferring the results for personality theme assessment to the scoring sheet; and
means for securely providing the totaled scoring sheet to the user.

26. The system of claim 22 wherein means for directing user interest for additional information to a selected data base further comprises:
means for providing personality snapshots to the user;
means for user review of descriptions of the personality snapshots;
means for user to match personality snapshot descriptions with career profile results;
means for user to rank personality themes according to dominant, secondary or combination categories; and
means for focusing user on career opportunities consistent with the personality themes ranking.

27. The system of claim 22 wherein means for directing user interest for additional information to a selected data base further comprises:
means for providing a user with a roster of a plurality of possible careers within the user's personal personality themes ranking;
means for providing the user with a roster of a plurality of possible industries within the user's personal personality themes ranking;
means for providing the user with contact person information within the career and industry rosters;
means for providing the user with networking suggestions within the career and industry rosters;
means for providing the user with sample informational interview questions within the career and industry rosters;
means for providing the user with a ranking chart; means for the user to identify a plurality of possible careers from the career roster;
means for the user to identify a plurality of preferred industries from the industries roster;
means for user to complete research on career options and industries;
means for user to refine the research;
means for user to list user's 3-6 highest values;
means for user to list user's 3-6 highest skills;
means for user to list user's top three values and top three skills in descending order on the ranking chart;
means for rating user's fit of careers to priorities; and
means for totaling the results to identify which career options best satisfy user priorities.

28. The system of claim 27 wherein means for directing user interest for additional information to a selected data base further comprises:
means for providing an action plan format to the user;
means for providing the user's name on the action plan format;
means for providing the current date on the action plan format;
means for user to consider possible barriers to achieve user's career goals and objectives;
means for user to create action plan lists within the action plan format to overcome the barriers;
means for user to enter the career goals into the action plan from the ranking chart;
means for user to list steps necessary to achieve each career goal;
means for user to assign a priority level to each step necessary to achieve each career goal;
means for user to list resources needed to achieve each step necessary to achieve each career goal;
means for user to set completion dates for each step necessary to achieve each career goal;
means for user to implement the action plan; and
means for user to modify the action plan as necessary to achieve the goals and objectives defined therein.

29. A data processing system for career assessment, comprising:
computer processor means for processing data;
storage means for storing data on a storage medium;
first means for initializing the storage medium;
second means for processing data regarding career profiles;
third means for processing data regarding understanding personality themes; and
fourth means for processing data regarding action planning and research.

30. A data processing system a claimed in claim 29, wherein first means further comprises:
means for inputting and storing on the storage medium a plurality of values sets;
means for inputting and storing on the storage medium a plurality of skills sets;
means for inputting and storing on the storage medium a plurality of careers interests sets;
means for inputting and storing on the storage medium a plurality of personality theme sets.

31. A data processing system a claimed in claim 30, wherein second means further comprises:
means for verifying that the storage medium is correct by retrieving from the storage medium the value identifying the storage medium;
means for creating locations on the storage medium for inputting, storing, correlating, ranking, and totaling input data regarding:
a user's values assessments;
a user's skills assessments;
a user's careers interests assessments; and
a user's personality theme assessments.

32. A data processing system a claimed in claim 31, wherein third means further comprises:
means for verifying that the storage medium is correct by retrieving from the storage medium the value identifying the storage medium;
means for retrieving from the storage medium and providing the user with personality snapshots;
means for retrieving from the storage medium and providing the user with descriptions of the personality snapshots;
means for retrieving from the storage medium and providing to the user matching personality snapshot descriptions with career profile results;
means for assisting the user to rank personality themes according to dominant, secondary or combination categories; and
means for allowing the user to focus on career opportunities consistent with the personality themes ranking.

33. A data processing system a claimed in claim 32, wherein fourth means further comprises:
means for verifying that the storage medium is correct by retrieving from the storage medium the value identifying the storage medium;
means for retrieving from the storage medium and providing the user with a roster of a plurality of possible careers within the user's personal personality themes ranking;
means for retrieving from the storage medium and providing the user with a roster of a plurality of possible industries within the user's personal personality themes ranking;
means for retrieving from the storage medium and providing the user with contact person information within the career and industry rosters;
means for retrieving from the storage medium and providing the user with networking suggestions within the career and industry rosters;
means for retrieving from the storage medium and providing the user with sample informational interview questions within the career and industry rosters;
means for retrieving from the storage medium and providing the user with a ranking chart;
means for allowing the user to identify a plurality of possible careers from the career roster;
means for allowing the user to identify a plurality of preferred industries from the industries roster;
means for allowing the user to complete research on career options and industries;
means for allowing the user to refine the research;
means for allowing the user to list and input to the storage medium the user's 3-6 highest values;
means for allowing the user to list and input to the storage medium the user's 3-6 highest skills;
means for allowing the user to list and input to the user's top three values and top three skills in descending order on the ranking chart;
means for rating user's fit of careers to priorities;
means for totaling the results to identify which career options best satisfy user priorities; and
means for inputting and storing user totals data in the storage medium.

34. A data processing system a claimed in claim 33, wherein fourth means further comprises:
means for verifying that the storage medium is correct by retrieving from the storage medium the value identifying the storage medium;
means for retrieving from the storage medium and providing the user with an action plan format;
means for retrieving from the storage medium and providing the user's name on the action plan format;
means for retrieving from the storage medium and providing the current date on the action plan format;
means for retrieving from the storage medium and providing the user a roster of possible barriers to achieve user's career goals and objectives;
means for retrieving from the storage medium and providing the user action plan lists within the action plan format to overcome the barriers;
means for allowing the user to enter career goals into the action plan from the ranking chart;
means for allowing the user to list steps necessary to achieve each career goal;
means for allowing the user to assign a priority level to each step necessary to achieve each career goal;
means for allowing the user to list resources needed to achieve each step necessary to achieve each career goal;
means for allowing the user to set completion dates for each step necessary to achieve each career goal;
means for allowing the user to implement the action plan;
means for allowing the user to modify the action plan as necessary to achieve the goals and objectives defined therein; and
means for inputting and storing action plan data in the storage medium.
